(19) United States
(12) Patent Application Publication
(10) Pub. No.: US 2024/0419435 A1
(43) Pub. Date: Dec. 19, 2024

(54) PRE-UPGRADE CHECK BASED UPGRADE OF APPLICATIONS

(71) Applicant: VMware LLC, Palo Aito, CA (US)

(72) Inventors: MAHENDRA BHAGAT, Pune (IN); Makarand Ramesh GAWADE, Pune (IN); Sagar Ratnakumar GANDHI, Pune (IN); Avinash BHATTARMAKKI, Pune (IN); Sanket MAHARNAWAR, Pune (IN); Vrushank UPADHYAY, Rajkot (IN); Ayan ADAK, Kolkata (IN)

(21) Appl. No.: 18/209,538

(22) Filed: Jun. 14, 2023

(51) Int. Cl. G06F 8/656; G06F 21/57

(52) U.S. Cl. CPC G06F 8/656; G06F 21/57

(57) ABSTRACT

An example method may include receiving an upgrade package to upgrade an application running in a compute node. Prior to an upgrade of the application, the method may include retrieving a pre-upgrade check corresponding to the upgrade package from a webserver. Further, the method may include executing the retrieved pre-upgrade check to provide a pre-upgrade check result. The pre-upgrade check result may include a first issue that affects the upgrade of the application and a first recommended resolution to resolve the first issue. Upon resolving the first issue by applying the first recommended resolution, the method may include performing the upgrade of the application based on the upgrade package.

### TECHNICAL FIELD

The present disclosure relates to computing environments, and more particularly to methods, techniques, and systems for upgrading applications based on pre-upgrade checks.

### BACKGROUND

Today, some software products, including upgrades, may be distributed over the Internet. When a user desired to change versions of a software product, the user can browse to a vendor's website, download a new version of software, and install the new version on the computer. After installation, the software product lifecycle management, such as software upgrade, becomes cumbersome and error-prone for several reasons. Software upgrades, although necessary for keeping a system secure and stable, are hardly immune to failure, which is one of the causes of users avoiding proceeding with the software upgrade as it becomes available. The upgrades may behave unexpectedly and cause unplanned delays, thereby causing instability and loss of productivity for the user of the affected device.

Users have a reasonable expectation that the software upgrades proceed smoothly, but developers, who do understand compatibilities, dependencies, and flaws in their own products, may have less knowledge about mismatched libraries, drivers, operating systems, and hardware components that they did not develop or the combination of configurations used. Incompatibilities may not be known until upgrades have been attempted.

### BRIEF DESCRIPTION OF THE DRAWINGS

FIG. 1 is a block diagram of an example system, depicting an upgrade recommendation module to upgrade an application in a compute node based on a pre-upgrade check;

FIG. 2 is a flow diagram illustrating an example method for performing an upgrade of an application based on a dynamic pre-upgrade check;

FIG. 3 is a sequence diagram illustrating an example sequence of events to upgrade an application based on a dynamic pre-upgrade check;

FIG. 4A is an example graphical user interface depicting availability of a pre-upgrade check associated with an application;

FIG. 4B is an example graphical user interface depicting an example pre-upgrade check result; and

FIG. 5 is a block diagram of an example management node including non-transitory computer-readable storage medium storing instructions to perform an upgrade of an application based on a pre-upgrade check.

The drawings described herein are for illustrative purposes and are not intended to limit the scope of the present subject matter in any way.

### DETAILED DESCRIPTION

Examples described herein may provide an enhanced computer-based and/or network-based method, technique, and system to upgrade applications based on pre-upgrade checks in a computing environment. The paragraphs to present an overview of the computing environment, existing methods to upgrade an application, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products.

In such computing environments, the software product including upgrades may be distributed over the Internet. Software product lifecycle management, such as a software product upgrade, can be a challenging task. General availability (GA) is a phase in the software release lifecycle when the software product becomes available to end users. When the software product reaches GA, the product becomes available through the company's general sales channel (e.g., a vendor's website). The security testing and approvals for the release are done against the secure hashing algorithm (SHA) of such released bundles. Therefore, when an upgraded version reaches the GA, the content of the upgraded version cannot be altered.

During the upgrade of the software product, issues may be observed, for instance, when migration code in a target version does not handle some corner cases in a source version or the data/format in the source version itself has some issue. After the GA, if customers start running into such upgrade issues, the release may have to be recalled and a new release/patch may have to be created. However, it may not be trivial to release a new release/patch since the new release/patch may have to go through the certification cycles in addition to the upgrade testing, which can be significantly expensive in terms of the work involved. Also, multiple new releases may impact the vendor's reputation with the customers. Also in some cases, the issue may be in the customer setups.

Examples described herein may provide a management node including an upgrade recommendation module to upgrade an application based on a pre-upgrade check. The upgrade recommendation module may receive an upgrade package to upgrade an application running in a compute node. Prior to an upgrade of the application, the upgrade recommendation module may poll a webserver to retrieve a pre-upgrade check corresponding to the upgrade package from the webserver. Further, the upgrade recommendation module may execute the retrieved pre-upgrade check to provide a pre-upgrade check result including an issue that affects the upgrade of the application and a recommended resolution to resolve the issue. Upon resolving the issue by applying the recommended resolution, the upgrade recommendation module may perform the upgrade of the application based on the upgrade package.

Thus, examples described herein may provide, prior to upgrading the application, a dynamic pre-upgrade check with an auto-resolution to resolve issues that are likely to affect the upgrade of the application. Since the released upgrade package (e.g., master upgrade bundle (.mub) file) cannot be altered, the upgrade framework can be enhanced to download a new pre-upgrade check file (e.g., a pre-upgrade check bundle (.pub)). After the GA, the new pre-upgrade check file can be released without altering checksums of the released upgrade package. With the examples described herein, latest pre-upgrade checks with auto-resolution code can be pushed based on issues seen by early adopters of the software product. Thus, the upgrade recommendation module overcomes the above-mentioned shortcomings for a next set of customers who perform the upgrade of the application, via downloading and executing the latest pre-upgrade checks.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

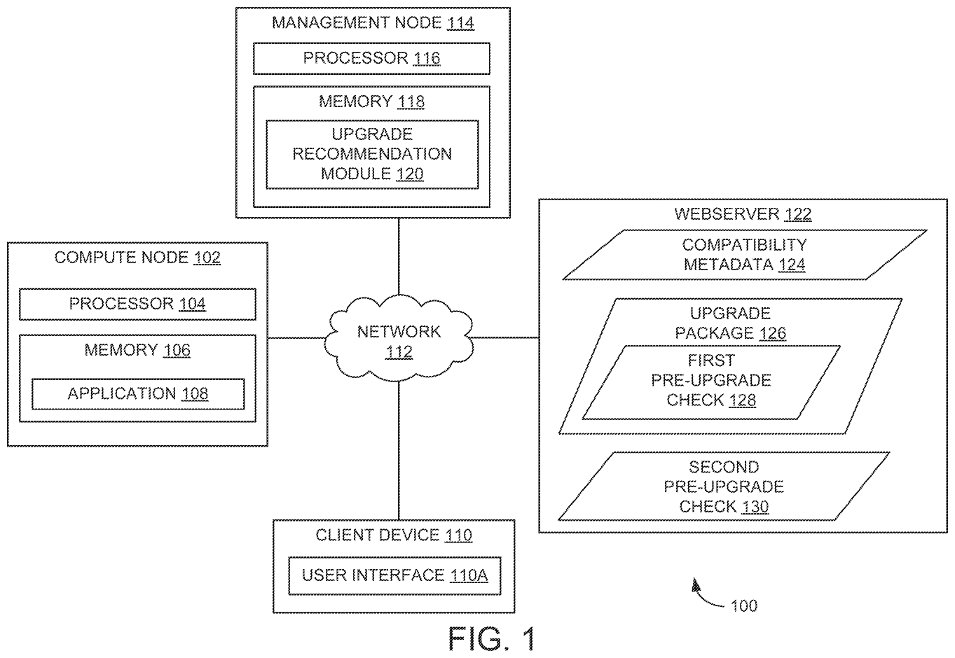

Referring now to the figures, FIG. 1 is a block diagram of an example system 100, depicting an upgrade recommendation module 120 to upgrade an application 108 based on a pre-upgrade check (e.g., a first pre-upgrade check 128, a second pre-upgrade check 130, or both). Example system 100 may be a cloud computing environment. For example, the cloud computing environment may be enabled by vSphere®, VMware's cloud computing virtualization platform. Further, system 100 may include multiple data centers. A data center may be a physical data center (e.g., an on-premises enterprise computing environment) and/or a virtual data center (e.g., a cloud computing environment, a virtualized environment, or the like). For example, the physical data center may include one or more physical host computing devices (e.g., servers), each of which may be configured to execute one or more applications. In another example, a number of virtual data centers may be deployed within the physical data center using virtual machines. The virtual data center may be a pool or collection of cloud infrastructure resources designed for enterprise needs. Furthermore, the virtual data center may be a virtual representation of the physical data center, complete with servers, storage clusters and networking components, all of which may reside in a virtual space being hosted by one or more physical data centers.

Further, system 100 may include a plurality of compute nodes or application hosts (e.g., a compute node 102). For example, compute node 102 may include physical host computing devices, virtual machines, containers, or any combination thereof. A physical host computing device may be a hardware-based device (e.g., a personal computer, a laptop, and the like) including an operating system (OS). The virtual machine may operate with its own guest OS on the physical host computing device using resources of the physical computer virtualized by virtualization software (e.g., a hypervisor, a virtual machine monitor, and the like). Containers can run on a host operating system without a hypervisor or separate operating system, such as a container that runs within Linux. A container can be provided by a virtual machine that includes a container virtualization layer (e.g., a Docker).

Further, compute node 102 may include a processor 104 and memory 106 coupled to processor 104. Furthermore, compute node 102 may execute at least one application (e.g., application 108). An example application, also referred to as an application program or application software, may be a software package or product that performs a specific function directly for an end user or, in some cases, for another application. An example application may include a distributed computing system (also referred to as a distributed software system). The distributed computing system may refer to a construct which involves various infrastructure parties that act together to enable a business service. For example, the distributed computing system includes components that are located on different networked computers, which communicate and coordinate their actions by passing messages to one another. An example application may include a server virtualization application (e.g., vSphere of VMware®), a storage virtualization application (e.g., vSAN of VMware®), a network virtualization and security application (e.g., NSX of VMware®), and the like. In other examples, the applications may include MySQL, Tomcat, Apache, word processors, database programs, web browsers, development tools, image editors, communication platforms, and the like.

Furthermore, system 100 includes a webserver 122. Example webserver 122 may include an upgrade package 126 (i.e., a new release) associated with application 108. In some examples, upgrade package 126 includes an embedded first pre-upgrade check 128. For example, first pre-upgrade check 128 is embedded as part of upgrade package 126 before upgrade package 126 is published for general availability to users. Furthermore, webserver 122 may include a second pre-upgrade check 130 associated with upgrade package 126. For example, second pre-upgrade check 130 may be added to webserver 122 after upgrade package 126 is published for general availability to the users. In some other examples, webserver 122 may include compatibility metadata 124 associated with the installation of upgrade package 126. For example, compatibility metadata 124 may include an indication of compatibility or incompatibility between a plurality of versions associated with application 108.

Further, system 100 includes a management node 114 in communication with compute node 102 via a network 112. Example network 112 can be a managed Internet protocol (IP) network administered by a service provider. For example, network 112 is implemented using wireless protocols and technologies, such as WiFi, WiMax, and the like. In other examples, network 112 can also be a packet-switched network such as a local area network, wide area network, metropolitan area network, Internet network, or other similar type of network environment. In yet other examples, network 112 is a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 114 includes a processor 116 and a memory 118 coupled to processor 116. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. The processor may, for example, include single or multiple cores on a chip, multiple cores across multiple chips, multiple cores across multiple devices, or suitable combinations thereof. The processor may be functional to fetch, decode, and execute instructions as described herein.

In other examples, management node 114 may be implemented as software program running on a physical computer or a virtual computer. Example management node 114 may be a VMware® vCenter™ server with at least some of the features available for such server. Memory 118 may include upgrade recommendation module 120. During operation, upgrade recommendation module 120 may retrieve an upgrade package 126 having first pre-upgrade check 128 from webserver 122. In an example, in response to receiving a request to upgrade application 108, upgrade recommendation module 120 may retrieve upgrade package 126 having first pre-upgrade check 128 from webserver 122. In some examples, when first pre-upgrade check 128 is not available in upgrade package 126, recommendation module 120 may retrieve only upgrade package 126 from webserver 122.

Further, prior to an upgrade of application 108, upgrade recommendation module 120 may poll webserver 122 to determine an availability of second pre-upgrade check 130 corresponding to upgrade package 126. In response to determining that second pre-upgrade check 130 is available, upgrade recommendation module 120 may retrieve second pre-upgrade check 130 from webserver 122.

Furthermore, upgrade recommendation module 120 may execute first pre-upgrade check 128 and second pre-upgrade check 130 to provide a pre-upgrade check result. An example pre-upgrade check result may include an issue that is likely to affect the upgrade of application 108 and a recommended resolution to resolve the issue. The recommended resolution may include resolution steps to enable a user to manually resolve the issue, an executable resolution script including a program to resolve the issue, or a combination thereof. For example, the pre-upgrade check result may include a warning, error, or both that is likely to occur during the upgrade of the application. Further, the pre-upgrade check result may include the recommended resolution based on the warning, error, or both that can occur during the upgrade of the application. In an example, the recommended resolution may be provided as part of the first pre-upgrade check, second pre-upgrade check, or both.

In an example, upgrade recommendation module 120 may provide the issue along with the recommended resolution on a user interface 110A of a client device 110. Further, upgrade recommendation module 120 may receive, via user interface 110A, a user input (e.g., the user's approval) to resolve the issue. Based on the user input, upgrade recommendation module 120 may execute the recommended resolution to resolve the issue. Upon resolving the issue by applying the recommended resolution, upgrade recommendation module 120 may perform, based on the upgrade package 126, the upgrade of application 108.

Thus, the issues observed after the general availability (i.e., after the upgraded version is released to the customers) may be mitigated by adding a new pre-upgrade check (i.e., the second pre-upgrade check) with an auto-resolution, without altering the sanctity of the general availability build/deliverables. Thus, the testing and certification done for the general availability build may not be invalidated. Thus, the pre-upgrade checks with auto-resolution code can be provided in webserver 122 based on issues seen by early adopters of the application. Further, examples described herein may ensure that the next set of customers upgrading to that release gets the benefit of the new pre-upgrade checks and also ensure an error-free upgrade.

In some examples, the functionalities described in FIG. 1, in relation to instructions to implement functions of upgrade recommendation module 120, and any additional instructions described herein in relation to the storage medium, may be implemented as engines or modules including any combination of hardware and programming to implement the functionalities of the modules or engines described herein. The functions of upgrade recommendation module 120 may also be implemented by a processor. In examples described herein, the processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more remote servers (e.g., compute nodes), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

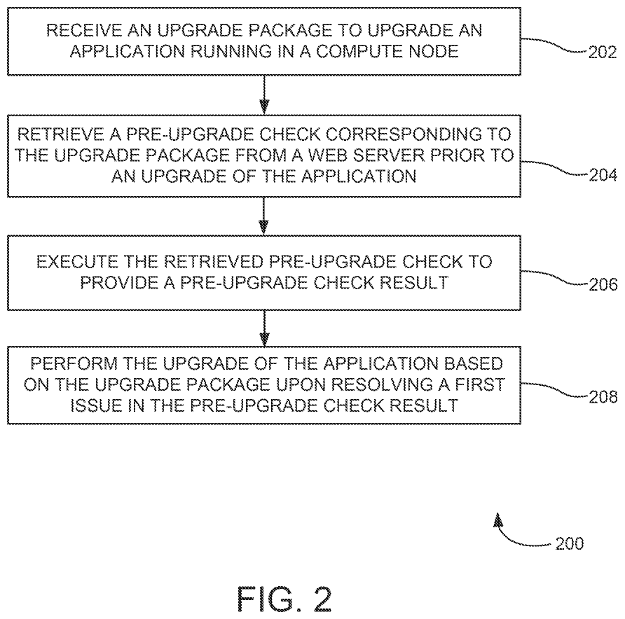

FIG. 2 is a flow diagram illustrating an example method 200 for performing an upgrade of an application based on a dynamic pre-upgrade check. Example method 200 depicted in FIG. 2 represents generalized illustrations, and other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 202, an upgrade package to upgrade an application running in a compute node may be received. At 204, prior to an upgrade of the application, a pre-upgrade check corresponding to the upgrade package may be retrieved from a webserver. In an example, retrieving the pre-upgrade check may include, prior to the upgrade of the application, polling the webserver to retrieve the pre-upgrade check including a first recommended resolution corresponding to the upgrade package. For example, retrieving the pre-upgrade check may include transmitting a HTTP get command to the webserver and receiving a response to the HTTP get command. The response may include the pre-upgrade check and the first recommended resolution associated with the upgrade package.

In an example, retrieving the pre-upgrade check may include, prior to the upgrade of the application, the webserver may be polled to retrieve compatibility metadata associated with the upgrade package. The compatibility metadata may include an indication of compatibility or incompatibility between a plurality of versions associated with the application. In an example, a cron job may be executed to obtain the compatibility metadata associated with the product from the webserver. Further, the compatibility metadata may be analyzed to determine whether a candidate upgrade version associated with the upgrade package is compatible with a current version of the application. Based on the analysis, the pre-upgrade check corresponding to the upgrade package may be retrieved.

At 206, the retrieved pre-upgrade check may be executed to provide a first pre-upgrade check result. An example first pre-upgrade check result may include a first issue that affects the upgrade of the application and the first recommended resolution to resolve the first issue. For example, the first pre-upgrade check result may include a warning, error, or both that is likely to occur during the upgrade of the application. Further, the pre-upgrade check may include the first recommended resolution based on the warning, the error, or both that can occur during the upgrade of the application. An example first recommended resolution may include resolution steps to enable a user to manually resolve the first issue, an executable resolution script including a program to resolve the first issue, or a combination thereof.

At 208, upon resolving the first issue by applying the first recommended resolution, the upgrade of the application may be performed based on the upgrade package. In an example, resolving the first issue may include:
providing the first issue along with the first recommended resolution associated with the first issue on a user interface of a client device,
receiving, via the user interface, a user input to resolve the first issue, and
based on the user input, executing the first recommended resolution to resolve the first issue.

In some examples, a default pre-upgrade check that is embedded in the upgrade package may be executed to provide a second pre-upgrade check result. In this example, the second pre-upgrade check result may include a second issue that affects the upgrade of the application and a second recommended resolution to resolve the second issue.

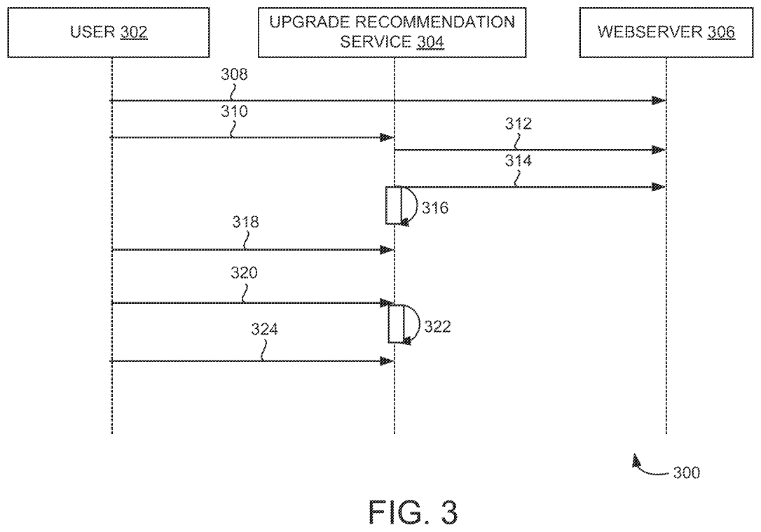

FIG. 3 is a sequence diagram 300 illustrating an example sequence of events to upgrade an application based on a dynamic pre-upgrade check. Sequence diagram 300 may represent the interactions and the operations involved in upgrading the application based on the pre-upgrade check. FIG. 3 illustrates process objects including a user 302, an upgrade recommendation service 304, and an external webserver 306 (e.g., vendor's website) along with their respective vertical lines originating from them. The vertical lines of user 302, upgrade recommendation service 304, and external webserver 306 may represent the processes that may exist simultaneously. The horizontal arrows (e.g., 308, 310, 312, 314, 318, 320, and 324) may represent the data flow steps between the vertical lines originating from their respective process objects (for e.g., user 302, upgrade recommendation service 304, and external webserver 306). Further, activation boxes (e.g., 316 and 322) between the horizontal arrows may represent the process that is being performed in the respective process object.

At 308, user 302 may use a client device to download an upgrade package (e.g., a master upgrade bundle (.mub) file) for a new release from webserver 306. At 310, user 302 may upload the downloaded upgrade package to upgrade recommendation service 304 (e.g., upgrade recommendation module 120 of FIG. 1). Upon receiving the upgrade package, upgrade recommendation service 304 may detect if a new pre-upgrade check bundle (.pub) is present for the release, at 312. For example, the .pub file may be provided to detect and correct issues that have been found after the .mub file is released to the customers. At 314, upgrade recommendation service 304 may download the new pre-upgrade check bundle (e.g., .pub file). At 316, upgrade recommendation service 304 may execute the old/default-upgrade check and the new pre-upgrade check. At 318, user 302 may get the result of the pre-upgrade checks. The pre-upgrade check result may provide recommended resolution steps based on each warning and/or error that may come up during the upgrade. For example, the warning may indicate “duplicate service registrations of the same type have been detected”. This warning may indicate that duplicate data for one or more services within a server has been detected. Unless corrected, the upgrade may fail. Thus, the pre-upgrade check result comes back with a “warning” alongside a “description” and a “resolution”. In other examples, the pre-upgrade check result comes back with an “error” alongside a “resolution”. For example, the warnings and errors can be, but not limited to, “certificate specified for SSL trust has expired”, “certificate specified for SSL trust is not yet valid”, “certificate specified for SSL trust cannot be parsed”, “duplicate service registrations of the same type has been detected”, and “SSL trust certificate does not match the current MACHINE_SSL_CERT for one of the legacy service registrations”.

At 320, user 302 may provide a user input to resolve the issues presented in the pre-upgrade check result. At 322, upgrade recommendation service 304 may execute resolution code embedded in the new pre-upgrade check to resolve the issues in a compute node (e.g., a virtual machine) that executes the application. Upon resolving the issue, at 324, user 302 may proceed to upgrade the application based on the upgrade package.

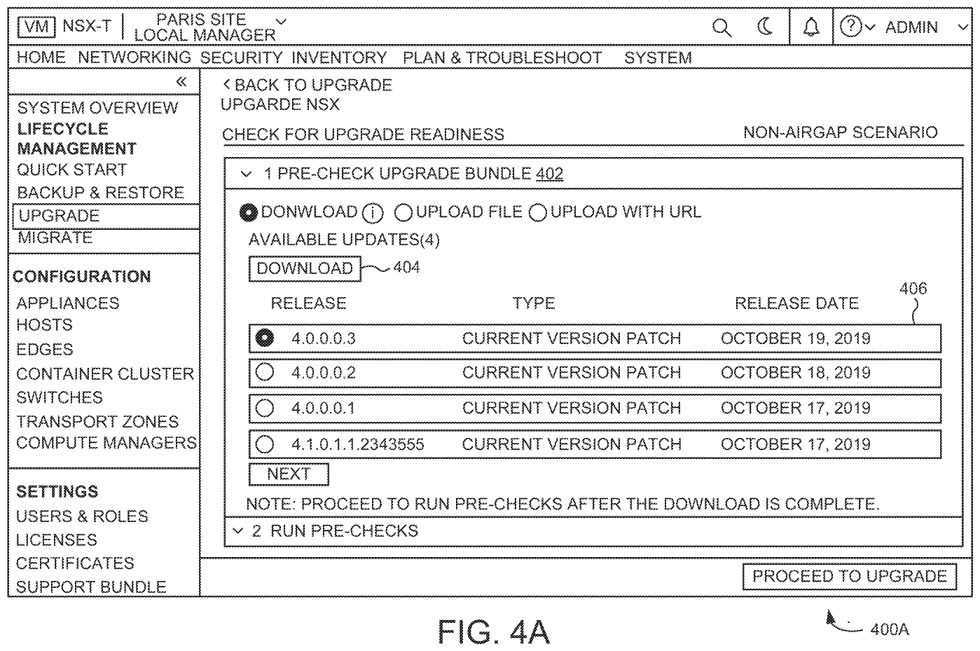

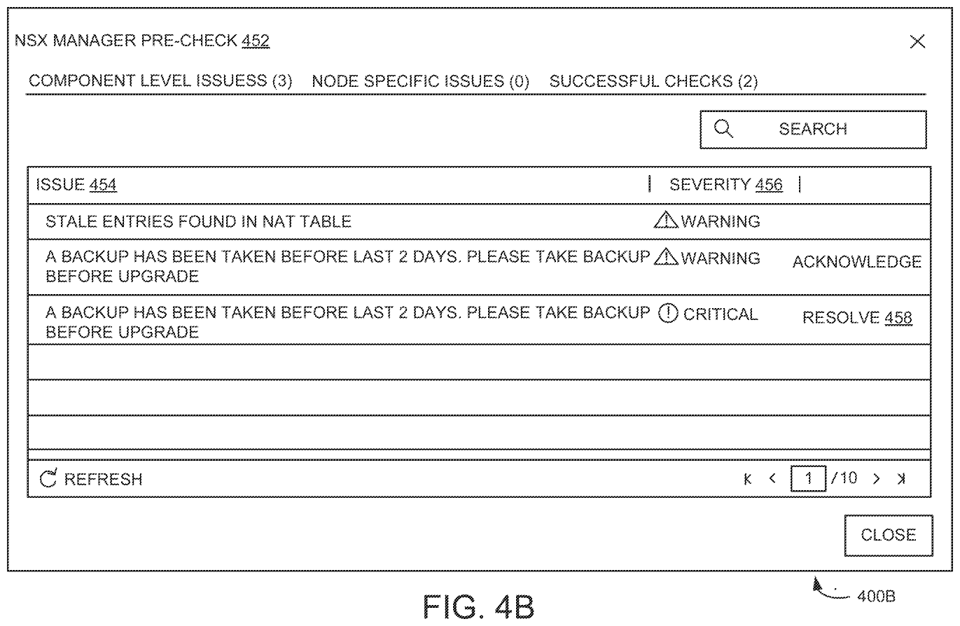

FIG. 4A is an example graphical user interface 400A depicting availability of a pre-upgrade check 402 corresponding to an upgrade package (e.g., a version patch 406). For example, user interface 400A is rendered on a client device of a user. In the example shown in FIG. 4A, graphical user interface 400A depicts various version patches along with corresponding release dates associated with the application. A version patch may refer to an upgrade package that is used to upgrade the application to a corresponding version. Further, graphical user interface 400A depicts an availability of pre-upgrade check 402 corresponding to version patch 406. Furthermore, user interface 400A depicts an option 404 to download pre-upgrade check 402 corresponding to version patch 406. In an example, pre-upgrade check 402 may include a resolution script to resolve an issue that is likely to affect the upgrade of the application.

FIG. 4B is an example graphical user interface 400B depicting an example pre-upgrade check result 452. Example pre-upgrade check result 452 may include component level issues, node specific issues, successful checks, and the like. Further, pre-upgrade check result 452 may include list of issues 454 and severity level 456 of the issues such as “warning”, “critical”, “error”, and the like. Furthermore, pre-upgrade check result 452 may provide an option 458 to resolve the issues. In an example, in response to a user selection of “resolve” option 458, a resolution script may be executed to resolve the issue.

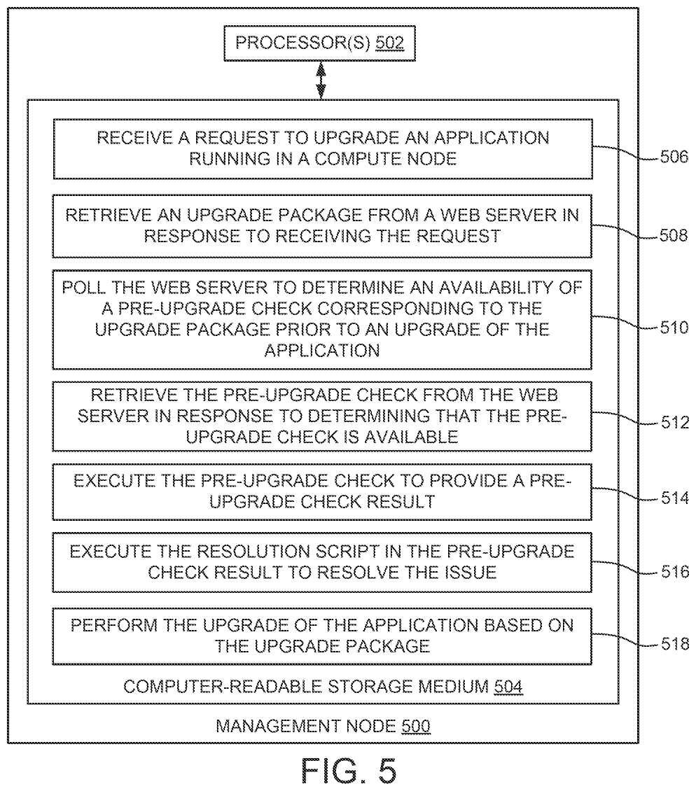

FIG. 5 is a block diagram of an example management node 500 including non-transitory computer-readable storage medium 504 storing instructions to perform an upgrade of an application based on a pre-upgrade check. Management node 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to management node 500.

Computer-readable storage medium 504 may store instructions 506, 508, 510, 512, 514, 516, and 518. Instructions 506 may be executed by processor 502 to receive a request to upgrade an application running in a compute node. In response to receiving the request, instructions 508 may be executed by processor 502 to retrieve an upgrade package from a webserver.

Prior to an upgrade of the application, instructions 510 may be executed by processor 402 to poll the webserver to determine an availability of a pre-upgrade check corresponding to the upgrade package. In an example, the pre-upgrade check may be added to the webserver after the upgrade package is published for general availability to users of the application. In response to determining that the pre-upgrade check is available, instructions 512 may be executed by processor 502 to retrieve the pre-upgrade check (e.g., a latest pre-upgrade check) from the webserver.

Instructions 514 may be executed by processor 502 to execute the pre-upgrade check to provide a pre-upgrade check result. An example pre-upgrade check result may include an issue that is likely to affect the upgrade of the application and a resolution script to resolve the issue. For example, the pre-upgrade check result may include a warning, error, or both that is likely to occur during the upgrade of the application. Further, the pre-upgrade check result may include the resolution script based on the warning, the error, or both that can occur during the upgrade of the application. In an example, the resolution script may be provided as part of the retrieved pre-upgrade check.

Instructions 516 may be executed by processor 502 to execute the resolution script to resolve the issue. In an example, instructions 516 to execute the resolution script may include instructions to provide the issue along with the resolution script associated with the issue on a user interface of a client device, receive, via the user interface, a user input to resolve the issue, and execute the resolution script to resolve the issue based on the user input. Upon resolving the issue, instructions 518 may be executed by processor 502 to perform the upgrade of the application based on the upgrade package.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
receiving an upgrade package to upgrade an application running in a compute node;
prior to an upgrade of the application, retrieving a pre-upgrade check corresponding to the upgrade package from a webserver;
executing the retrieved pre-upgrade check to provide a first pre-upgrade check result including:
a first issue that affects the upgrade of the application; and
a first recommended resolution to resolve the first issue; and
upon resolving the first issue by applying the first recommended resolution, performing the upgrade of the application based on the upgrade package.

2. The method of claim 1, further comprising:
executing a default pre-upgrade check, that is embedded in the upgrade package, to provide a second pre-upgrade check result, wherein the second pre-upgrade check result includes:
a second issue that affects the upgrade of the application; and
a second recommended resolution to resolve the second issue.

3. The method of claim 1, wherein retrieving the pre-upgrade check comprises:
prior to the upgrade of the application, polling the webserver to retrieve the pre-upgrade check including the first recommended resolution corresponding to the upgrade package.

4. The method of claim 1, wherein resolving the first issue comprises:
providing the first issue along with the first recommended resolution associated with the first issue on a user interface of a client device;
receiving, via the user interface, a user input to resolve the first issue; and
based on the user input, executing the first recommended resolution to resolve the first issue.

5. The method of claim 1, wherein retrieving the pre-upgrade check comprises:
prior to the upgrade of the application, polling the webserver to retrieve compatibility metadata associated with the upgrade package, wherein the compatibility metadata includes an indication of compatibility or incompatibility between a plurality of versions associated with the application;
analyzing the compatibility metadata to determine whether a candidate upgrade version associated with the upgrade package is compatible with a current version of the application; and
retrieving the pre-upgrade check corresponding to the upgrade package based on the analysis.

6. The method of claim 1, wherein executing the retrieved pre-upgrade check comprises:
executing the retrieved pre-upgrade check to provide the first pre-upgrade check result including:
a warning, error, or both that is likely to occur during the upgrade of the application; and
the first recommended resolution based on the warning, the error, or both that can occur during the upgrade of the application.

7. The method of claim 1, wherein the first recommended resolution comprises:
resolution steps to enable a user to manually resolve the first issue;
an executable resolution script including a program to resolve the first issue; or
a combination thereof.

8. The method of claim 1, wherein retrieving the pre-upgrade check comprises:
transmitting a HTTP get command to the webserver; and
receiving a response to the HTTP get command, the response including the pre-upgrade check and the first recommended resolution associated with the upgrade package.

9. A non-transitory computer-readable storage medium comprising instructions executable by a processor of a management node to:
receive a request to upgrade an application running in a compute node;
in response to receiving the request, retrieve an upgrade package from a webserver;
prior to an upgrade of the application, polling the webserver to determine an availability of a pre-upgrade check corresponding to the upgrade package;
in response to determining that the pre-upgrade check is available, retrieve the pre-upgrade check from the webserver;
execute the pre-upgrade check to provide a pre-upgrade check result including:
an issue that is likely to affect the upgrade of the application; and
a resolution script to resolve the issue;
execute the resolution script to resolve the issue; and
upon resolving the issue, perform the upgrade of the application based on the upgrade package.

10. The non-transitory computer-readable storage medium of claim 9, wherein the pre-upgrade check is added to the webserver after the upgrade package is published for general availability to users of the application.

11. The non-transitory computer-readable storage medium of claim 9, wherein instructions to execute the resolution script comprise instructions to:
provide the issue along with the resolution script associated with the issue on a user interface of a client device;
receive, via the user interface, a user input to resolve the issue; and
based on the user input, execute the resolution script to resolve the issue.

12. The non-transitory computer-readable storage medium of claim 9, wherein instructions to execute the pre-upgrade check comprise instructions to:
execute the pre-upgrade check to provide the pre-upgrade check result including:
a warning, error, or both that is likely to occur during the upgrade of the application; and
the resolution script based on the warning, the error, or both that can occur during the upgrade of the application.

13. The non-transitory computer-readable storage medium of claim 9, wherein the resolution script is provided as part of the retrieved pre-upgrade check.

14. A management node comprising:
a processor; and
a memory coupled to the processor, wherein the memory comprises an upgrade recommendation module to:
retrieve, from a webserver, an upgrade package having a first pre-upgrade check;
prior to an upgrade of an application, polling the webserver to determine an availability of a second pre-upgrade check corresponding to the upgrade package;
in response to determining that the second pre-upgrade check is available, retrieve the second pre-upgrade check from the webserver;
execute the first pre-upgrade check and the second pre-upgrade check to provide a pre-upgrade check result including:
an issue that is likely to affect the upgrade of the application; and
a recommended resolution to resolve the issue; and
upon resolving the issue by applying the recommended resolution, perform the upgrade of the application based on the upgrade package.

15. The management node of claim 14, wherein the upgrade recommendation module is to:
retrieve the upgrade package having the first pre-upgrade check from the webserver in response to receiving a request to upgrade the application.

16. The management node of claim 14, wherein the upgrade recommendation module is to:
provide the issue along with the recommended resolution on a user interface of a client device;
receive, via the user interface, a user input to resolve the issue; and
execute the recommended resolution to resolve the issue.

17. The management node of claim 14, wherein the pre-upgrade check result comprises:
a warning, error, or both that is likely to occur during the upgrade of the application; and
the recommended resolution based on the warning, error, or both that can occur during the upgrade of the application.

18. The management node of claim 14, wherein the recommended resolution comprises:
resolution steps to enable a user to manually resolve the issue;
an executable resolution script including a program to resolve the issue; or
a combination thereof.

19. The management node of claim 14, wherein the first pre-upgrade check is embedded as part of the upgrade package before the upgrade package is published for general availability to users, and wherein the second pre-upgrade check is added to the webserver after the upgrade package is published for general availability to the users.

20. The management node of claim 14, wherein the recommended resolution is provided as part of the first pre-upgrade check, second pre-upgrade check, or both.
